(19) United States
(12) Patent Application Publication
(10) Pub. No.: US 2007/0084646 A1
(43) Pub. Date: Apr. 19, 2007

(54) Simple control device for skid steer vehicles

(76) Inventor: Donald Ernest Scruggs, Chino, CA (US)

Correspondence Address: Donald E. Scruggs, 4464 Walnut Ave., Chino, CA, 91710, US

(21) Appl. No.: 11/545,667

(22) Filed: Oct. 10, 2006

Related U.S. Application Data
(60) Provisional application No. 60/727,352, filed on Oct. 13, 2005.

(51) Int. Cl. B62D 11/02; B60K 26/00

(52) U.S. Cl. 180/6.2; 180/333

(57) ABSTRACT

Simple to operate and easy to maintain manually powered, non-electronic, skid steering apparatus using conventional appearing steering wheels or handle bars, fixed or tiltable for ease of access, with some having built in throttle control for operator comfort and ease of new operator training.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### FIELD OF THE INVENTION

This invention relates to manually powered steering control devices for skid steered vehicles where braking is applied to wheels or tracks on one side to slow those wheels or tracks and provide for the wheels or tracks on the opposite side to travel, thus causing the vehicle to turn in the direction in which the steering device is turned.

### BACKGROUND OF THE INVENTION

A current practice used on differential geared skid steered vehicles is to have two levers, each attached to a braking device in such a fashion as when one lever is activated the braking device on that side slows the differential output shaft on that side causing the vehicle to turn in the direction of the slowed side and activating both levers stops the vehicle.

### OBJECTS OF THE INVENTION

It is a main object of this invention to provide a simple to operate and easy to maintain mechanism and system which includes a steering wheel or handle bars to skid steer a vehicle and also bring it to a stop.

It is another object of this invention to provide a familiar appearing main control, such as the steering wheels and handle bars presently used on automobiles, bicycles and motorcycles, and to provide comfort and ease of learning to new operators.

An additional object of the invention is to provide several variations of the invention to meet differing needs of vehicle designers.

It is a further object of this invention to provide a means whereby the engine throttle control is integrated with a steering wheel or handle bars to further control a skid steered vehicle.

### OPERATING PRINCIPALS AND PREFERRED EMBODIMENT

The preferred embodiment of this invention is a simple cable system similar to that shown in FIGS. 25, 26, 27 and 28 herein, whereby turning a steering wheel or handle bars counter-clockwise to the left brakes and slows the left side wheels or tracks and causes a left turn, while turning the steering wheel or handle bars clockwise to the right brakes and slows the right side wheels or tracks and causes a right turn, and pushing forward or pulling back on the steering wheel or handle bars brakes all wheels or tracks and stops the vehicle. Incorporating an automotive type steering wheel or bicycle type handle bars on a skid steered vehicle provide a more familiar steering apparatus and steering manner and makes learning less difficult for new vehicle operators.

Skid steered four wheel vehicles are quit common in construction, demolition and material loading. They are usually small and short wheelbased and built to operate on relatively flat and firm surfaces. When the set of wheels or track on one side of the vehicle is stopped, the wheels on the opposite side must have enough traction to overcome the resistance of pivoting the opposite front wheel or point of contact plus that required to drag the farthest stopped wheel or the farthermost point of contact of a track.

Vehicles with six wheels can be made easier to steer than four wheeled vehicles, if the front set of wheels and the rear set of wheels are positions slightly above the center set of wheels. This positioning creates a cradle effect which causes the vehicle when braked on one side for skid steering to rock forward on the front and center set of wheels thus reducing the skidding resistance from that of front to rear to the shorter distance of that of front to center. This is true even if the vehicle has a suspension system. The suspension system, although appearing to keep all wheels or tracks on the ground, reduces the loading on the rear wheels or sections of track and increases the loading on the front wheels or sections of track, giving the still rolling wheels or track more traction and thus creating a similar effect to that of a non-suspension skid steered vehicle. The shorter the fore and aft length between the two sets of wheels in contact with the ground and the wider the side to side distance of the sets of wheels or tracks is important in the turning agility of the vehicle. The closer the front and rear set of wheels or track in contact with the ground are to each other relative to the wider apart distance of the wheels or tracks the more easily controlled and responsive is the vehicle.

Tracked vehicles, which are basically vehicles with tracks around wheels, and vehicles with eight or more wheels can be designed and built with a similar cradle advantage. The key element is in providing a familiar appearing steering control, i.e. wheel or handle bars in place of levers, to provide a new operator with a comfortable environment and ease the learning process.

It is important that potential new operators are presented with what appears to be a familiar and comfortable control environment to help them overcome any reservations they may have about trying something new. Most potential new operators are already familiar with a steering wheel in a car or handle bars on a bicycle and are set more at ease when seeing such devices on a vehicle they are about to operate. This is especially true with persons being offered a sport type all terrain or off highway vehicle for the first time.

Other embodiments, ramifications and combinations of the designs shown herein for operator familiar and comfortable skid steer operating devices are equally preferred depending upon the type of vehicle on which the invention is to be used.

### DESCRIPTION OF FIGURES

FIG. 1 is a diagram showing the layout of a typical six wheel vehicle with three wheels on the left side, 30, an optional track, 31, a steering wheel, 32, in its center position, an optional right side track, 33, and three wheels, 34, on the right side of the vehicle.

FIG. 2 is a diagram of the same vehicle as in FIG. 1, except that the steering wheel, 32, is turned to the left, activating the braking (not shown) on the left side and causing the three wheels, 30, and or the optional track, 31, on the left side of the vehicle to slow down or stop, allowing the three wheels, 34, on the right side of the vehicle and or the optional track, 33, to continue to rotate and propel the vehicle, causing the vehicle to pivot on the left hand wheels or track and turn the vehicle to the left.

FIG. 3 is a diagram of the same vehicle as in FIGS. 1 and 2, except that the steering wheel, 32, is turned to the right, activating the braking (not shown) on the right side and causing the three wheels, 34, and or the optional track, 33, on the right side of the vehicle to slow down or stop, allowing the three wheels on the left side of the vehicle, 30, and or the optional track, 31, to continue to rotate and propel the vehicle, causing the vehicle to pivot on the right hand wheels or track and turn the vehicle to the right.

FIG. 4 is a diagram of the same vehicle as in FIGS. 1, 2 and 3, showing the vehicle in a straight forward position, with its steering wheel, 32, pushed forward to its braking position, 35, where the steering mechanism activates the braking system (not shown) on both sides of the vehicle to bring the vehicle to a stop.

FIG. 5 is a side view of a six wheel vehicle illustrating the skid steering advantage of the cradle effect on the wheels and or track by the center point, 37, set lower than the rear point, 36, and the front point 38. Also shown for reference is the location of the steering wheel, 32.

FIG. 6 is a view looking down on a hydraulic cylinder steering assembly, in a static position, incorporating a steering wheel, 49, mounted on a steering shaft, 39, which slides through the shaft guide, 48, and the spring sheath, 50, and is pushed backwards by the spring, 40, with the hydraulic driver cylinders, 41 and 43, attached through their respective auto adjusting links, 46 and 44, to the actuator arm, 51, and itemizing the hydraulic fluid tubes, 45 and 42, leading to brakes (not shown). See FIG. 8 for end on view.

FIG. 7 is a view looking down on the same hydraulic cylinder steering assembly shown in FIG. 6, except that the steering wheel, 49, has been turned counter clockwise, to the left, and through the shaft, 39, has moved the actuator arm, 51, which closes up the auto adjusting link, 46, on the left side and compresses the cylinder, 41, sending hydraulic fluid and pressure through the hydraulic tube, 45, which leads to a brake on the wheels or track on the left side of the vehicle, while the right side auto adjusting link, 44, is extended and has no effect on the right side hydraulic cylinder, 43, which does not affect the fluid in that cylinder and hydraulic tube, 42. This action causes the vehicle to turn left. During this left turn activity the spring, 40, presses lightly on the end of the shaft, 39, which is retained from backward movement by the stop, 47, and is guided by the guide, 48, and the spring sheath, 50.

FIG. 8 is an end view of FIG. 6, with a steering wheel in a static position, showing the left side hydraulic cylinder, 41, auto adjusting link, 46, hydraulic tube, 45, steering wheel, 49, steering shaft, 39, and actuator arm, 51, right side hydraulic cylinder, 43, auto adjusting link, 44, and hydraulic tube, 42. See FIGS. 14, 15, 16, and 17 for auto adjusting link details.

FIG. 9 is an end on view of the steering assembly shown in FIG. 7, where a steering wheel, 49, and a shaft, 39, are rotated counter clockwise, moving the actuator arm, 51, to the left, which closes the auto adjusting link, 46, which in turn pushes on the hydraulic cylinder, 41, sending hydraulic fluid and pressure down the hydraulic tube, 45, to a left side brake (not shown).

FIG. 10 is a view looking down on the same hydraulic steering assembly shown in FIGS. 6 and 7 except that the steering wheel, 49, has been turned clockwise, to the right, and through the shaft, 39, has moved the actuator arm, 51, to the right which closes up the auto adjusting link, 44, on the right side and compresses the right hydraulic cylinder, 43, sending hydraulic fluid and pressure through the hydraulic tube, 42, while the left auto adjusting link, 46, extends and has no effect on the left side hydraulic cylinder, 41, which does not affect the fluid in that cylinder and hydraulic tube, 45. During this right turn activity, the spring, 40, presses lightly on the end of the shaft, 39, which is retained from backward movement by the stop, 47, and is guided by the guide, 48, and the spring sheath, 50.

FIG. 11 is a view looking down on the same hydraulic steering assembly shown in FIGS. 6, 7 and 10 except that the steering wheel, 49A (its original position), has been pushed forward to its braking position, 49B, and through the shaft, 39, has moved the actuator arm, 51, forward, closing up the auto adjusting links on both sides, 44 and 46, and compressing both hydraulic cylinders, 43 and 41, sending hydraulic fluid and pressure through both hydraulic tubes, 42 and 45, to the right and left brakes, stopping the vehicle. During this activity, the spring, 40, is compressed by the end of the shaft, 39, while the stop, 47, is moved forward from the guide, 48.

FIG. 12 is an end on view of the steering assembly shown in FIG. 10 with the steering wheel turned clockwise, to the right, and through the shaft, 39, actuator arm, 51, and auto adjusting linkage, 44, has compressed the hydraulic cylinder, 43, sending hydraulic fluid and pressure through the hydraulic tube 42, to the right side brake, while extending the left auto adjusting linkage, 46, and thus not affecting the left hydraulic cylinder, 41, and its hydraulic tube, 45. Consequently, the left side brake is not engaged and wheels and or track on that side cause the vehicle to pivot to the right.

FIG. 13 is an end on view of the steering assembly shown in FIG. 11 where the steering wheel, 49, shaft, 39, and actuator arm, 51, are in the center position, but are pushed forward closing the left and right auto adjusting linkage, 46 and 44, and putting pressure on both the left and right hydraulic cylinders, 41 and 43, thus sending hydraulic fluid and pressure to brakes (not shown) on both sides of the vehicle, to stop the vehicle.

FIG. 14 is a diagram of a hydraulic cylinder and linkage assembly in its compressed position, showing a hydraulic cylinder, 55, an enlargement detail circled, 56, (enlargement shown as FIG. 15), the hydraulic cylinder shaft, 59, hydraulic outlet fitting, 57, and hydraulic tube, 58, which connects to a axle shaft brake (not shown).

FIG. 15 is the enlarged detail of the circle, 56, in FIG. 14, showing the hydraulic cylinder shaft, 59, the outer sleeve, 60, and the inner sleeve 61, of the auto adjusting linkage, with retaining screws, 62, noted.

FIG. 16 is a diagram of the same assembly as FIG. 14, except in the center or neutral position, with a hydraulic cylinder, 55, hydraulic cylinder shaft, 59, an outer sleeve, 60, and an inner sleeve, 61, on the auto adjusting linkage, and hydraulic outlet fitting, 57, and hydraulic tube, 58.

FIG. 17 is a diagram of the same assembly as FIGS. 14 and 16, showing the assembly in the extended position, with a hydraulic cylinder, 55, with its hydraulic cylinder shaft, 59, fully extended, an outer sleeve, 60, and an inner sleeve, 61, on the auto adjusting linkage, also extended, so that there is no hydraulic pressure through the hydraulic outlet fitting, 57, and hydraulic tube, 58, and thus no stopping by the brake attached to that assembly.

FIG. 18 is a three quarter view of a handle bar type steering, 69, on a steering shaft, 64, with a built in engine throttle control, 65, and its throttle cable, 66, as an alternate to the steering wheel shown as item 70 in FIG. 19.

FIG. 19 is a oblique schematic of a steering wheel, 70, shaft, 64, actuator arm, 68, inside sleeve, 61, and outside sleeve, 60, of auto adjusting linkage, a hydraulic cylinder, 55, hydraulic cylinder shaft and hydraulic tube, 58, leading to a brake, 71, which is mounted on a automotive type differential, 73, and having another brake, 72, on the opposite side. The brakes, 71 and 72, can be drum type, band type or caliper-disk type brakes. The picture is to illustrate the relationship of major components of the subject skid steering system.

FIG. 20 is a perspective view of a type of hydraulic cylinder actuated skid steering system in its at rest position where the steering wheel, 80, is mounted on a shaft, 74, which is held by slides, 75 and 78, and a swash plate, 77, is mounted at an angle on the same shaft, 74, with cam rollers, 76, attached to levers, 82 and 83, to which are attached clevis rods, 79 and 84, fit into brake master cylinders, 81 and 86, with attached hydraulic tubes, 85 and 87, leading off to brakes (not shown).

FIG. 21 is a side view of the assembly shown in FIG. 20, of a steering wheel, 80, shaft, 74, shaft slides, 75 and 78, and a swash plate, 77, mounted at an angle on shaft 74 and a cam roller, 76, mounted on a lever (not marked).

FIG. 22 is a perspective view of the same mechanism as that shown in FIG. 20, except the steering wheel, 80, has been turned counter clockwise to the left, rotating the shaft, 74, and the swash plate, 77, counter clockwise, causing the swash plate, 77, to push the left cam roller, 76, which in turn moves the lever, 83, and clevis rod, 84, towards the master brake cylinder, 86, sending hydraulic fluid and pressure through the hydraulic tube, 85, to a left side brake (not shown). Note that the master brake cylinder, 81, on the right is unaffected as the surface of the swash plate, 77, on that side moves away from the cam roller (not shown) an thus does not move the lever, 82, or the clevis rod, 79.

FIG. 23 is a perspective view of the same mechanism as that shown in FIGS. 20 and 22, except that the steering wheel, 80, has been turned clockwise to the right, rotating the shaft, 74, and the angled swash plate, 77, clockwise, causing the surface of the angled swash plate, 77, to push the cam roller (not numbered or shown) on the right, which in turn moves the lever, 82, and the clevis rod, 79, towards the master brake cylinder, 81, sending hydraulic fluid and pressure through the hydraulic tube, 87, to a right side brake (not shown). Note that the master brake cylinder, 86, on the left is unaffected as the surface of the angled swash plate, 77, on the left side moves away from the cam roller, 76, and thus does not move the lever or clevis rod on that side.

FIG. 24 is a perspective view of the same mechanism as that shown in FIGS. 20, 22 and 23, except that the steering wheel, 80A, in its center position has been pushed forward, 80B, sliding the shaft, 74, forward and moving angled swash plate, 77A forward where it presses both cam rollers, 76, causing the levers, 82 and 83, to which each is attached, to move both clevis rods, 79 and 84, into both brake cylinders, 81 and 86, forcing hydraulic fluid through both hydraulic tubes, 85 and 87, causing brakes on both sides of the vehicle to engage and stop the vehicle.

FIG. 25 is a three dimensional isometric sketch of a layout of a six wheeled skid steer vehicle with tracks, 98, shown over wheels. A steering wheel, 90, is mounted on a shaft, 89, which slides and or rotates in chassis mounted guides, 91, and has arms, 92, extending out each side, onto which are mounted balled tie rod ends, 93, into which are fitted flex cables, 94, with each cable passing between a pair of pulley wheels, 95, which are fixed firmly to the chassis. The flex cables are inside housings, 96, which guide each flex cable from the left side of the steering apparatus to the right hand brake, shown here as a outside band type, 102, and the cable from the right side of the steering apparatus to the left hand brake. The differential gear housing, 100, is in the center of the chassis, and is driven by a shaft from the power supply, 99. The chain drives, 97, shown on this vehicle, are driven by axle shaft driven sprockets, extending from the differential housing, 100.

FIG. 26 is a view from the top of FIG. 28, showing an axle shaft, 101, onto which is mounted an external surfaced brake drum, 103, around which is wrapped a brake band, 102, which is tightened or loosened by movement of the cable end piece, 104, on a flex cable, 94, which is held within a housing, 96.

FIG. 27 is an enlarged view of the mechanism associated with the steering wheel in FIG. 25, except that it shows how in moving the steering wheel from its center or neutral position, 90A, to its braking position, 90B, causes the arms, 92, and the balled tie rod ends, 93, to pull the flex cable, 94, through the pulley wheels, 95, which applies pressure to both the left and right brake bands shown as item 102 in FIGS. 26 and 28, thus braking the vehicle.

FIG. 28 is a side view of the banded brake in FIG. 26, showing a flex cable, 94, a cable housing, 96, a cable end piece, 104, an axle shaft, 101, on which an external surfaced brake drum, 103, is mounted and a brake band, 102, which is tightened by the flex cable, 94, extending from the steering apparatus in FIG. 25 and more detailed in FIG. 27.

FIG. 29 depicts a handle bar, 107, with a throttle control, 108, and throttle control cable, 109, which can be substituted for the steering wheel shown in any of the designs herein. The throttle control, 108, and throttle control cable, 109, are also attached to steering wheels shown herein.

FIG. 30 shows a tilt up steering assembly as in FIGS. 6 to 13 and FIG. 19, with a left hand hydraulic cylinder, 111, a right hand hydraulic cylinder, 112, a steering wheel in driving position, 113B, and in tilted up position, 113A, a hydraulic cylinder mount, 114, a tilt up frame, 115, a pivot shaft, 116, attached to the tilt up frame, a pivot mount, 118, and a hold down latch, 126.

FIG. 31 is a tilt up version of a cable actuated steering system as shown in FIGS. 25 and 27, with a steering wheel in the driving position, 119B, and in the tilted up position, 119A, with a upper steering shaft slide guide, 120 (attached to the tilt up frame, not detailed here), an arm, 121, attached to a steering shaft, a lower steering shaft slide guide, 122, attached to a tilt up frame, 123, a cable pulley, 124, which is at the pivot center line of the tilt up frame, 123, so as to not affect the cable tension when the unit is tilted, a pivot shaft, 125, which is attached to the tilt up frame, a pivot mount, 118, and a hold down latch, 126, as detailed in FIG. 32.

FIG. 32 is a shortened detail of the tilt up frame latching device, 133, similar to a automotive rear hatch or trunk latch, with an actuator cable, 129, extending from an actuator plate, 135, which rotates around a pivot post, 134, so that pulling on the vehicle left side cable, 130, or on the vehicle right side cable, 132, or on the operator cable, 131, will open the latch mechanism, 133, and release a latching lug, 128, attached to the tilt up frame (not shown).

FIG. 33 is an isometric view of an angled swash plate and roller cam steering mechanism, on a pivoting frame, 139, built for ease of vehicle access, similar to the designs shown in FIGS. 20 to 24, where the steering wheel is in its center drive position, 136B, and its tilted up position, 136A, pointing out an angled swash plate, 137, pivot points 138, and a latching mechanism, 140, as detailed in FIG. 32.

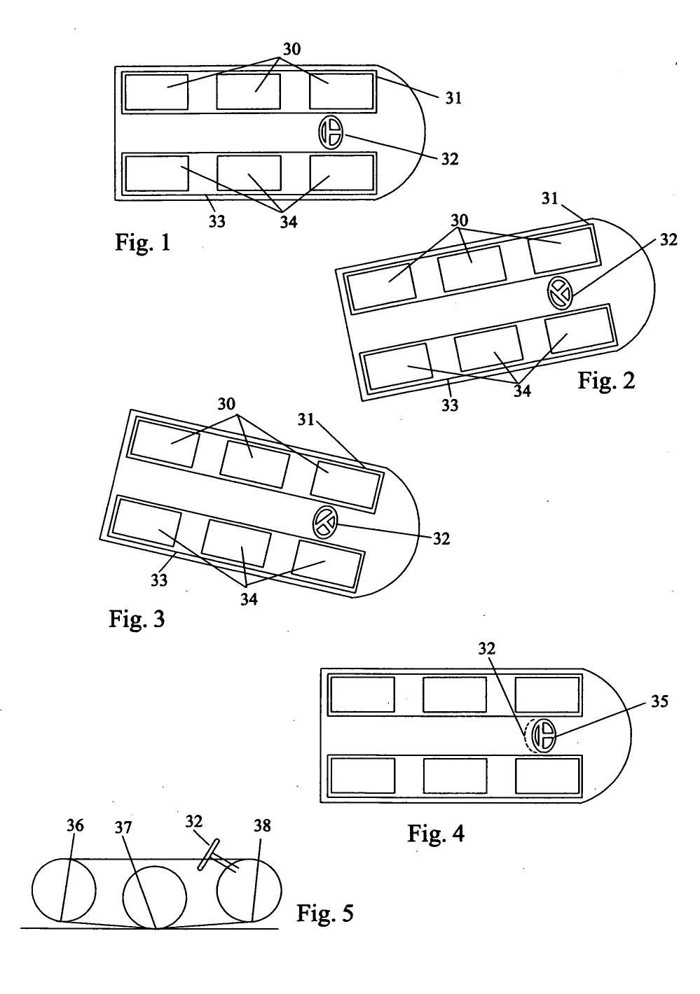

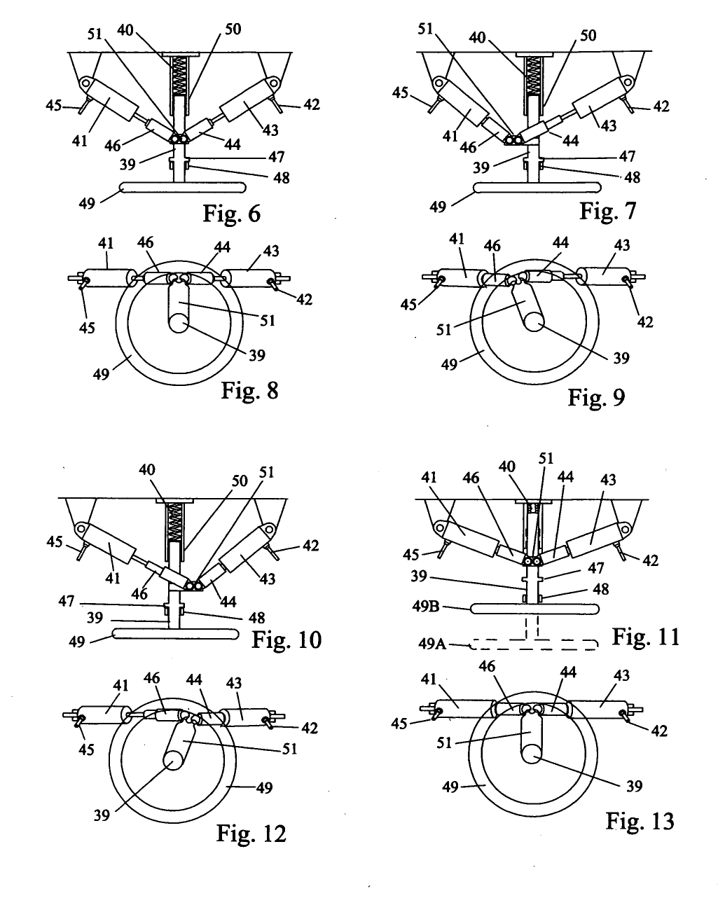

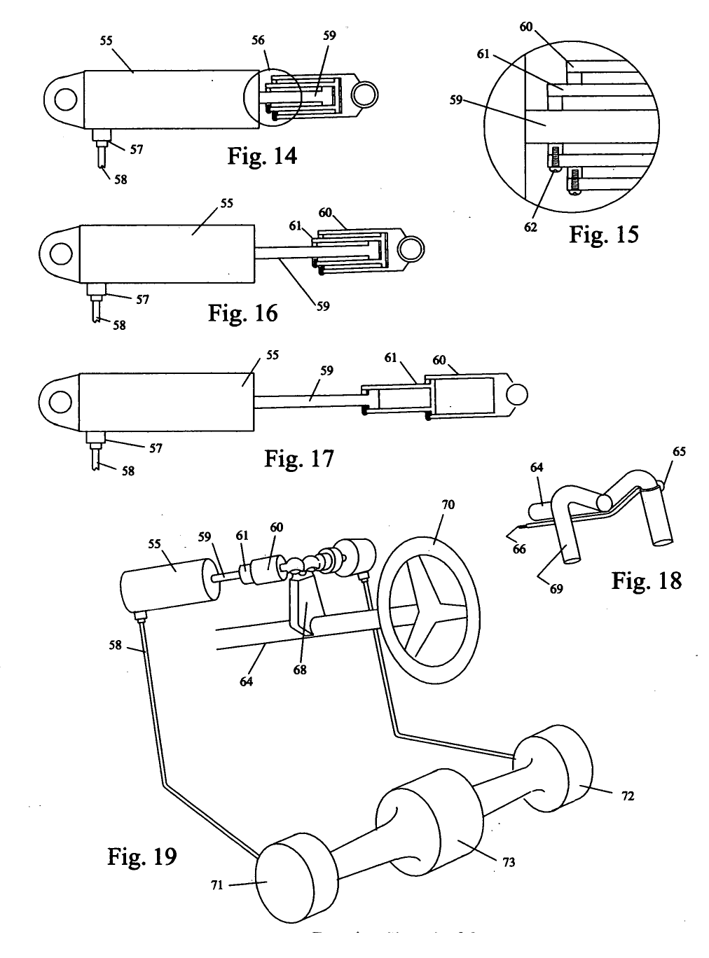

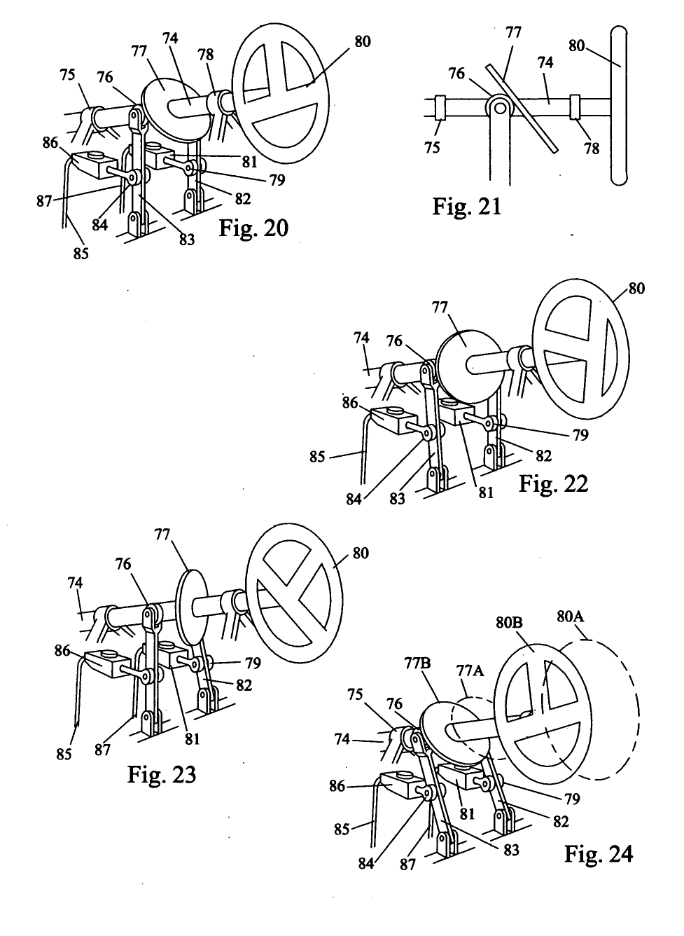

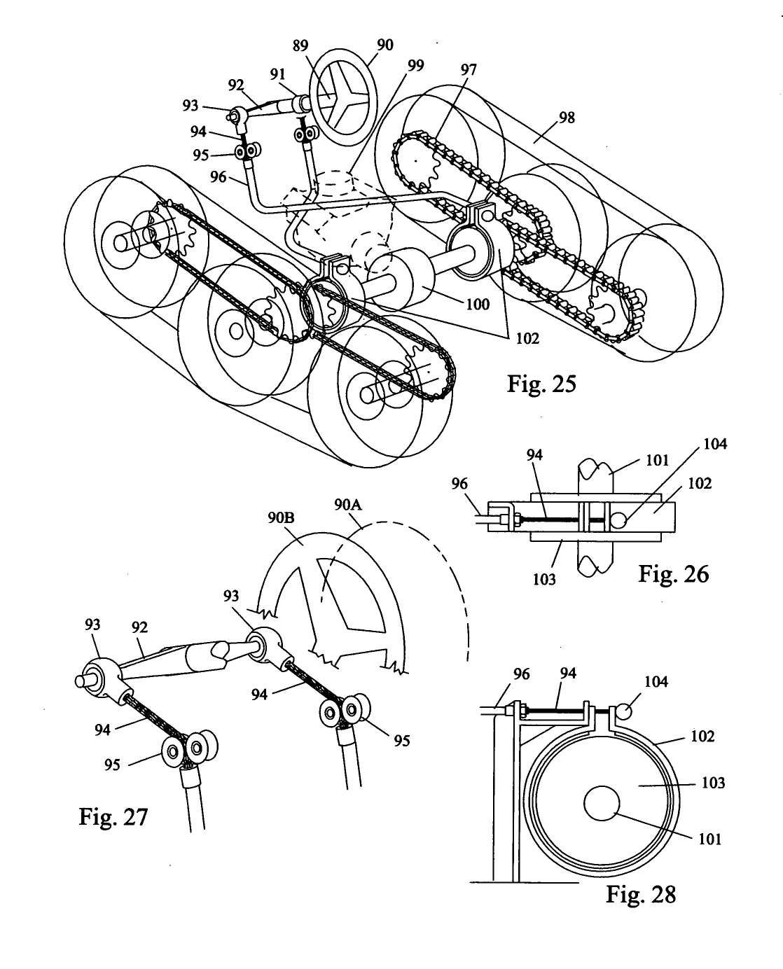

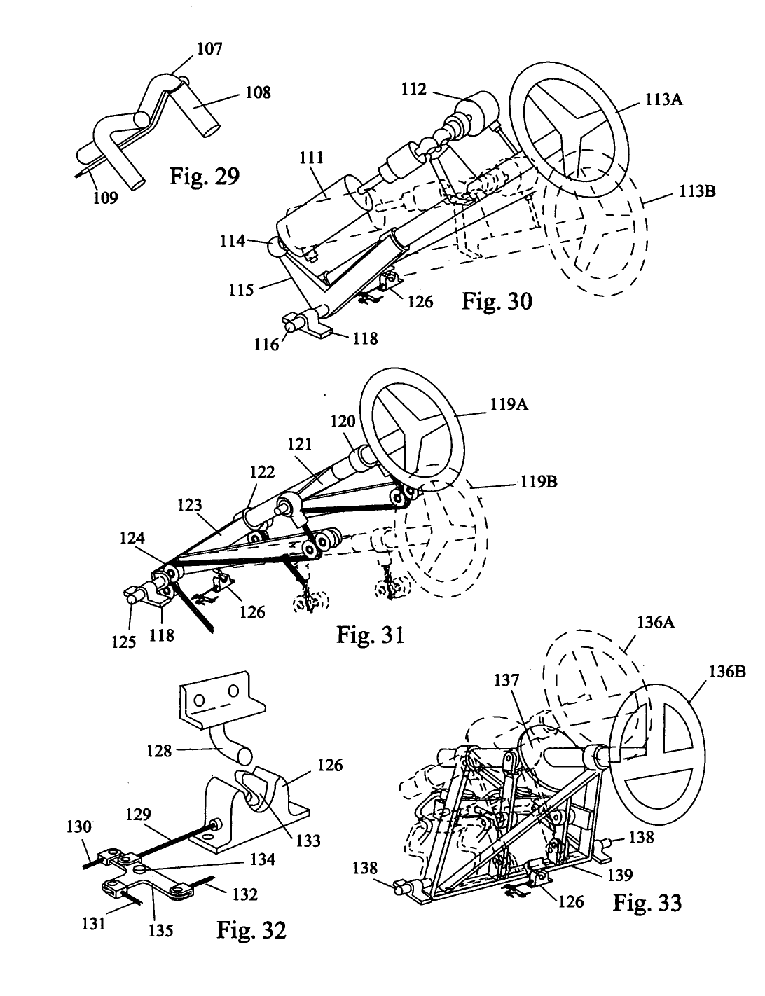

I claim:

1. A manually powered non-electronic steering device and apparatus for skid steer vehicles having a steering wheel by which such a vehicle can be made to turn left by turning the steering wheel counter clockwise to the left or be made to turn right by turning the steering wheel clockwise to the right or be made to stop by pulling the steering wheel rearward.

2. A steering device as in claim 1, where a handle bar is used in place of the steering wheel.

3. A steering device as in claim 1 operated by cables attached to an arm or arms on the steering wheel assembly whereby the cables are further attached to and operate brakes on the driving systems on opposite sides of a vehicle.

4. A steering device as in claim 1 operated by the transfer of hydraulic power where an arm or arms on the steering wheel assembly engage hydraulic cylinders to apply actuating pressure to brakes on the driving systems on opposite sides of vehicle.

5. A steering device as in claim 1 operated by hydraulic power where a plate mounted at an angle to the centerline of a shaft acts as a swash plate cam and engages hydraulic cylinders to apply actuating pressure to brakes on the driving systems on opposite sides of a vehicle.

6. A device as in claim 1, also having a power control mechanism mounted on the steering mechanism.

7. A device as in claim 1, incorporated within a vehicle.

8. A device as in claim 1, where the mechanism is detachable and can be moved to facilitate access to parts of the vehicle.
